(19) United States
(12) Patent Application Publication
(10) Pub. No.: US 2003/0069773 A1
(43) Pub. Date: Apr. 10, 2003

(54) Performance reporting

(76) Inventors: William J. Hladik JR., Harrisburg, NC (US); Michelle L. Smith, Sweeden, KY (US)

Correspondence Address: HOFFMAN WARNICK & D'ALESSANDRO, LLC, 3 E-COMM SQUARE, ALBANY, NY, 12207

(21) Appl. No.: 09/972,232

(22) Filed: Oct. 5, 2001

(51) Int. Cl. G06F 17/60

(52) U.S. Cl. 705/7

(57) ABSTRACT

The present invention provides a method, system and program product that provides a user with a high level view of the health of their business by reporting parameter performance in a simple, “at a glance” display. Each parameter's performance is represented using a common indicator icon which can show the parameter's current performance, immediately previous performance, baseline performance and trend as compared to previous values for the measurement. The system allows users to view parameter performances using the same reporting system. The invention also allows a user to organize several parameters into logical groupings and obtain a weighted average of their performance; retrieve detailed information about a given parameter; and/or check his/her parameter's performance via a small, wireless, pervasive device.

### BACKGROUND OF THE INVENTION

1. Technical Field

The present invention relates generally to performance reporting and, more particularly, to a method, system and program product for reporting performance of a plurality of measurements having different measurement dimensions.

2. Related Art

Measuring performance is an exceedingly difficult task for a business or entity operating in today's information rich society. There are a number of reasons for this problem:

Time requirements to review all parameters of a business are oftentimes cited as being excessive. In addition, the amount of data and/or number of parameter measurements may be overwhelming and, hence, difficult to evaluate. Furthermore, data may not be communicated in a timely fashion.

Another obstacle is that raw data is oftentimes presented as raw data. When raw data is not placed in context by, for example, comparison to a parameter target or a previous parameter measurement value where no target is set, it makes a determination on how a particular parameter is performing very difficult. In addition, the raw data may lack context relative to overall business performance or a part of the overall business. Consequently, a user cannot effectively make decisions in an appropriate manner. Furthermore, a user may not want to see raw data, but prefers only to know how his/her responsibilities are performing trend-wise, i.e., are they doing better or worse.

Another challenge is that different measurements often have different measurement dimensions and cannot be compared easily. For instance, budgetary-type parameters are measured in monetary figures while customer satisfaction is measured as a percentage. As a result, a user has difficulty determining how his/her business is actually performing.

Current systems also do not adequately provide, in a quick and concise manner, a parameter's historical performance. Questions such as: “Has this parameter always been good/bad?” or “Was it good/bad last time?” are frequently asked, but not easily answered. For example, where a parameter has historically been performing well, a bad performance may be excused as an aberration. In contrast, a continually poor performing parameter, may require further examination. Hence, there is a need to understand something about the history of the parameter's measurements and about the degree to which a measurement misses or exceeds its target. One mechanism used by some systems are charts graphing or plotting measurement data through twelve or more months of the year. Frequently, however, measurements that are more than six months old are irrelevant and the most recent last period is important. The one exception to knowing something historical beyond the last measurement period is the baseline. There are a variety of reasons for this. For example, sometimes the baseline is an industry mark to be achieved. In other cases, the baselines are year-end values for the measurement. In another case, the baseline is the average for the measurement throughout the prior months of the year.

Current systems also do not adequately provide personal preferences so that data can be meaningfully grouped and summarized. A system that does not allow a user to arrange data in a way he/she understands hinders decision making. It would also be beneficial if a performance reporting system allowed access to more in-depth information upon request, and allowed those that provide the data to customize how the data is presented. It would also be beneficial if the system was portable.

An additional challenge, where numerous reporting systems are implemented, is getting the systems to work together or compliment one another. As a result, users oftentimes must be accustom to various systems.

In view of the foregoing, there is a need in the art for a method, system and program product that can quickly, concisely report to a user how a parameter is performing.

### SUMMARY OF THE INVENTION

The present invention provides a method, system and program product that provides a user with a high level view of the health of their business by reporting parameter performance in a simple, “at a glance” display. Each parameter's performance is represented using a common indicator icon which can show the parameter's current performance, immediately previous performance, baseline performance and trend as compared to previous values for the measurement. The system allows users to view parameter performances using the same reporting system. The invention also allows a user to organize several parameters into logical groupings and obtain a weighted average of their performance; retrieve detailed information about a given parameter; and/or check his/her parameter's performance via a small, wireless, pervasive device. Those supplying data are also provided with a mechanism to make existing measurement data available; record special notes about a particular measurement; and/or record a detailed information location (e.g. another web site or notes database).

A first aspect of the invention is directed to a method for reporting performance of a plurality of measurements, the method comprising the steps of: obtaining a plurality of measurements, at least two measurements having different measurement dimensions; calculating a performance of each measurement to a corresponding target; and reporting performance of each of the measurements using an indicator that is independent of measurement dimension.

A second aspect of the invention is directed to a system for reporting performance, the system comprising: a reporter that provides a performance indicator for a measurement relative to a corresponding target, wherein the indicator includes at least two portions, each portion indicating a different performance characteristic.

A third aspect of the invention is directed to a computer program product comprising a computer useable medium having computer readable program code embodied therein for reporting on performance, the program product comprising: program code configured to obtain a plurality of measurements, at least two measurements having different measurement dimensions; and program code configured to report performance of each of the measurements compared to a respective target using an indicator that is independent of measurement dimension.

A fourth aspect of the invention is directed to a system for reporting performance for a measurement, the system comprising: means for calculating at least one performance characteristic; and means for reporting a plurality performance characteristics of the measurement in a single indicator.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 shows a block diagram of a performance reporting system;

FIG. 2 shows a graphical user interface of a reporter of the system of FIG. 1;

FIG. 3 shows a first embodiment of a performance indicator including an indicator icon;

FIG. 4 shows an exemplary overall performance indicator section of the GUI of FIG. 2;

FIG. 5 shows a variety of positions for the performance indicator icon of FIG. 3;

FIG. 6 shows a first level data drill down GUI for a measurement parameter attainable by the data retriever of FIG. 1;

FIG. 7 shows a first level data drill down GUI for a category parameter attainable by the data retriever of FIG. 1;

FIG. 8 shows a first level data drill down GUI for a reporter set parameter attainable by the data retriever of FIG. 1; and

FIG. 9 shows alternative embodiments for the performance indicator icon.

### DETAILED DESCRIPTION OF THE INVENTION

For convenience purposes only, the following outline is used in the description:

I. Overview

II. Performance Reporting System and Method

III. Reporter and Indicator

A. Overview/Definitions

B. Categorizer

C. Weighter

D. Indicator Icon Details

E. Data Retriever

F. Controller

G. Alternatives

I. Overview

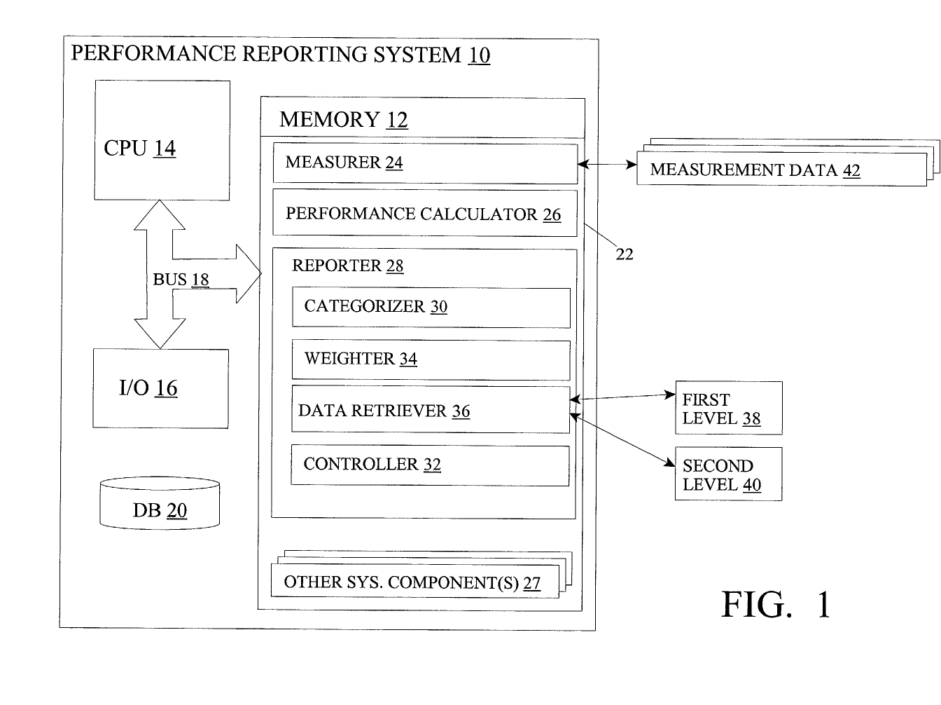

With reference to the accompanying drawings, FIG. 1 is a block diagram of a performance reporting system 10 in accordance with the invention. Performance reporting system 10 preferably includes a memory 12, a central processing unit (CPU) 14, input/output devices (I/O) 16 and a bus 18. A database 20 may also be provided for storage of data relative to processing tasks. Memory 12 preferably includes a program product 22 that, when executed by CPU 14, comprises various functional capabilities described in further detail below. Memory 12 (and database 20) may comprise any known type of data storage system and/or transmission media, including magnetic media, optical media, random access memory (RAM), read only memory (ROM), a data object, etc. Moreover, memory 12 (and database 20) may reside at a single physical location comprising one or more types of data storage, or be distributed across a plurality of physical systems. CPU 14 may likewise comprise a single processing unit, or a plurality of processing units distributed across one or more locations. A server computer typically comprises an advanced mid-range multiprocessor-based server, such as the RS6000 from IBM, utilizing standard operating system software, which is designed to drive the operation of the particular hardware and which is compatible with other system components and I/O controllers. I/O 16 may comprise any known type of input/output device including a network system, modem, keyboard, mouse, scanner, voice recognition system, CRT, printer, disc drives, etc. Additional components, such as cache memory, communication systems, system software, etc., may also be incorporated into system 10.

As shown in FIG. 1, program product 22 may include a measurer 24, a performance calculator 26, a reporter 28 and other system components 27. Reporter 28 may include a categorizer 30, a weighter 34, a data retriever 36 and a controller 32.

II. Performance Reporting System and Method

A. Overview/Definitions:

For purposes of explanation, the following definitions will be utilized. A “parameter” is a topic or a grouping of topics for which a measurement can be made to determine performance. A single topic parameter may be, for example, daily equipment expenses; daily customer satisfaction; customers attained; etc. Each single topic parameter has a corresponding single measurement (defined below) and, hence, may be referred to as a “measurement parameter.”

Each parameter for a grouping of topics may also have a cumulative measurement.

A “category parameter” or “category” is a convenient grouping of parameters. An exemplary category may be a product line sales, which would include individual product's sales. Another example of where a category is advantageous is where a particular measurement parameter has a chronological underpinning, e.g., monthly cumulative customer satisfaction rating, quarterly customer satisfaction rating, etc.

A “reporter set parameter” or “reporter set” is a convenient grouping of categories. An exemplary reporter set may be a division's sales, which would include a number of product lines' sales. It should be recognized that some parameters may be “nested,” i.e., part of a larger grouping of parameters. For example, the above described division's sales reporter set maybe a parameter in an even more comprehensive corporate sales reporter set, which would include a number of divisions' sales. Measurement parameters, category parameters and reporter set parameters may be referred to, cumulatively, simply as parameters.

A “measurement” is any quantification of a parameter that can be compared to a target to determine how well that parameter is performing relative to the target, i.e., to attain the parameter's performance. Measurements may be single, discrete or cumulative in nature. Exemplary measurements are money expended on equipment, a monthly cumulative customer satisfaction rating, etc. Each measurement has a “measurement dimension” such as percentage, monetary figure, number, etc. For example, a customer satisfaction parameter may be a percentage; an expense will have a monetary figure; a number of new customers will be a number; etc.

“Performance” is how well a measurement performed against a corresponding target. Each performance figure is generally calculated as follows: (measurement value−target)/target, as will be described further below.

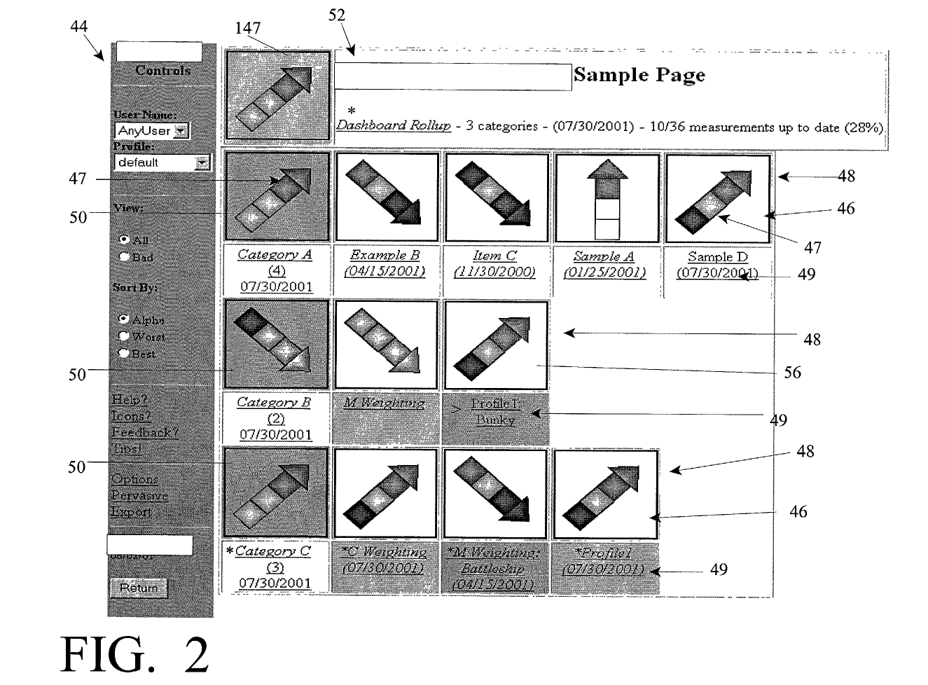

Turning to FIG. 2, the logic of system 10 and the method of the invention will be described in greater detail relative to a reporter graphical user interface (GUI) 44 created by reporter 28. Operation of system 10 begins by measurer 24 obtaining or accessing measurement data 42 (FIG. 1). Measurement data 42 may be obtained in real time, or may be accessed from a data source that has been populated by other users.

Next, a performance for each measurement is calculated by performance calculator 26 by comparing the measurement to a corresponding target, i.e., implementing (measurement value−target)/target. Where a parameter includes a grouping of individual measurements or is a category or a reporter set, performances can be combined using weighted averages to illustrate how well the parameter performed. This will be discussed in more detail relative to weighter 34. In general, however, zero percent or above means the measurement(s) met or exceeded the target by that percentage. Below zero percent means the measurement(s) missed the target by that percentage. Calculation of performance as a percentage allows measurements having different measurement dimensions to be compared and/or combined. For instance, a performance for meeting a monetary figure can be compared and/or combined with a performance for meeting a number of new customers.

Performance can also be calculated for different chronological periods for a particular parameter. For instance, performance calculator 26, in one embodiment, may calculate performance for: a baseline measurement period, the last measurement period, and the current measurement period. Accordingly, there can be three or more performance figures per parameter. The present description will, however, be limited to describing a baseline performance, last performance, and current performance.

As noted above, each performance figure is generally calculated as follows: (measurement value−target)/target. For example, assuming a financial measurement of $25,000 to be compared against a target of $35,000. The measurement value is $10,000 below the parameter's target, which means it is under performing by $10,000/$35,000=0.2857 (or 28.57%).

Performance calculator 26 also evaluates the parameter's goal. More specifically, calculator 26 determines whether the parameter's goal is to be above its target or below its target (or within a range). Continuing with our example, most financial parameters strive to be below a given target. Accordingly, system 10 considers the performance in the above example to be +28.57%. That is, the parameter “beats its target by 28.57%.” If the goal was to be above target, the performance would be −28.57%, meaning the parameter missed it's target by 28.57%. In the special circumstance that the target is zero, then the performance is defaulted to 0%. Similarly, if the target or value is blank, then performance is defaulted to 0%.

A parameter with a goal defined as a range will have a 0% performance if it measures within the target range and it will have a negative performance if it measures outside of that target range (either on the high side or the low side). For example, if a parameter has a target range of 25% to 35%. In system 10, if the parameter's measurement is equal to or between 25% and 35%, performance is 0%. If the measurement is below 25% or above 35%, the performance is negative and is calculated as described above.

As mentioned above, performance calculator 26 preferably calculates the performance of the baseline, last and current periods for all parameters. Anything zero percent (0%) or higher means the parameter beat its target and is depicted as a Green status, as will be described below. Anything less than zero percent (0%) means the parameter missed its target. As described below, performance calculator then evaluates “by how much did the parameter miss its target.”

A final step of operation, as shown in FIG. 2, includes reporting performance by reporter 28 for the parameter(s) using a reporter GUI 44 having a performance indicator(s) 46 that is independent of measurement dimension. Further details of the method and system logic will become apparent from the following discussion of reporter 28 and indicator 46.

III. Reporter and Indicator

A number of reporter GUIs 44 may be established within system 10 for a corresponding number of parameters, e.g., a number of reporter sets. A reporter set may be nested as part of another reporter set, as will be described below. The reporter GUI 44, shown in FIG. 2, is for a reporter set entitled “Sample Page.”

With continuing reference to FIG. 2, reporter GUI 44 reports on a variety of parameters' performance with each individual parameter depicted by a common performance indicator 46. Reporter GUI 44 also reports on categories 48, which are indicated by rows in reporter GUI 44. Each category 48 includes a comprehensive category performance indicator 50 that is common with indicator 46.

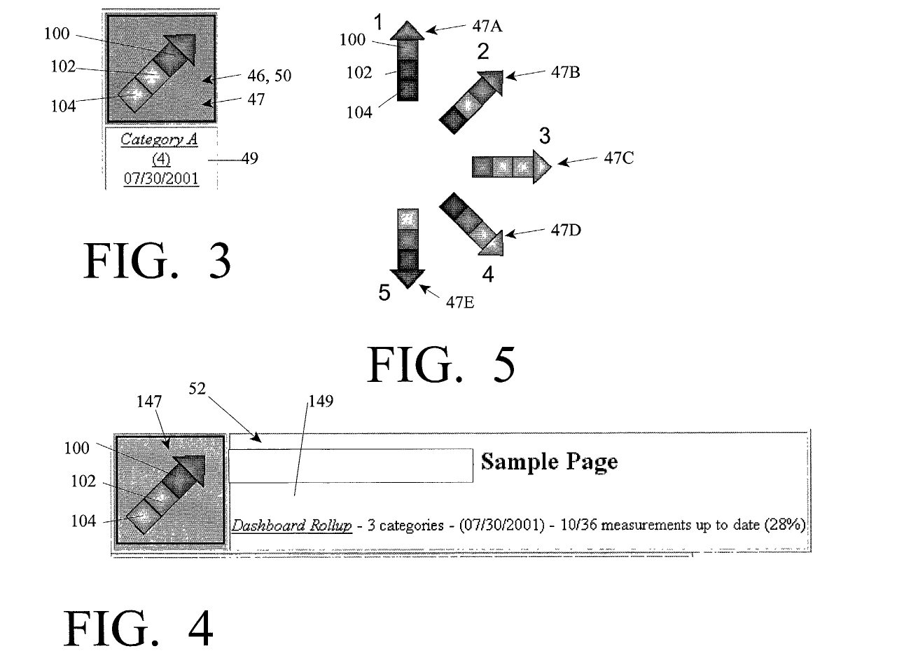

As shown in FIG. 3, each performance indicator 46, 50 includes an actual performance indicator icon 47 and may include a detail portion 49. Detail portion 49 for a measurement parameter may include the name of the measurement parameter and a measurement date. In one embodiment, an indication of the staleness of the measurement data can be made, for example, by the name of the measurement parameter being presented in italics. Of course, a variety of other mechanisms for making this indication may also be used. Returning to FIG. 2, a detail portion 49 for a category performance indicator 50 may include the name of the category parameter and a date representing the most recent date of all measurements currently shown in that category (row). A number in parenthesis may also be provided representing the number of measurement parameters currently shown in that category (row). An indication of the staleness of the category measurement data can be also be made, as discussed above. In addition, a background color for a category performance indicator 50 may be different compared to one for a measurement parameter performance indicator 46 to distinguish the indicators.

Category performance indicator 50 reports on a combined performance of the measurement parameters in the category as calculated by performance calculator 26. The combined performance is an average of all of the measurement parameters in that category (row) as determined by performance calculator 26. Since each of the measurement parameters in a given category may have the same measurement dimension or different measurement dimension, the process by which category performance is calculated/averaged does not use the data for each measurement. Rather, a weighted average of the performance of each measurement parameter is used, which is defined below relative to weighter 34.

As shown in FIG. 2, reporter GUI 44 may also include a reporter set or overall performance indicator 52 that provides a reporter set performance indicator icon 147 reporting the performance of all categories in the reporter set combined, as calculated by performance calculator 26. As shown in FIGS. 2 and 4, reporter set performance indicator 52 includes performance indicator icon 147 and a detail portion 149. Detail portion 149 may include the name of the reporter set that reporter GUI 44 is reporting on (e.g., Sample Page); a number representing the number of category parameters currently shown; a date representing the most recent date of all measurement parameters currently shown in that reporter set; and an indication of how many measurement parameters' data is up to date. An indication of the staleness of the measurement data can also be made, as discussed above.

A. Categorizer

Categorizer 30 allows a user to determine which parameter(s) measurement(s) will be provided in a particular reporter set (and reporter GUI 44) and how they will be categorized. Furthermore, categorizer 30 allows a user to establish one or more combined performance indicators 56 (FIG. 2), which, upon selection by for instance clicking on the icon or name thereof, act as links to at least one other nested reporter set and corresponding reporter GUI(s) 44. In other words, a measurement parameter within a reporter set parameter may represent a reporter set parameter in and of itself. In either of the above cases, as shown in FIG. 2, the combined performance indicator 56 may denote that it is such an indicator by having a colored background behind its detail portion 47. Different backgrounds may represent different types of reporter set nesting scenarios, e.g., a reporter set or a category. As an alternative, an identifier such as “>” may be used to indicate certain types of nesting. Selection of this identifier may call up another nested reporter set. A name of the nested reporter set may also be provided for identification, e.g., Profile 1: Bunky (FIG. 2). A staleness indication is also possible here, as described above.

Categorizer 30 also allows a user to add or remove a measurement parameter, a category parameter or a reporter set parameter. There can be an unlimited number of categories for any given reporter set. Scroll bars to scroll up and down to see other categories may be provided as known in the art.

Categorizer 30 may be implemented in any well known fashion. For instance, a separate graphical user interface (not shown) allowing selection/removal of parameters and grouping into categories and reporter sets may be utilized.

B. Weighter

Weighter 34 allows assignment of weights to a category parameter or a measurement parameter for use in calculating weighted averages. Weighting is beneficial in determining a category performance for a category having a number of measurements and a reporter set performance for a reporter set having a number of categories. Weights can be assigned to a category parameter or a measurement parameter by any numerical number on any relative scale. Hence, a user can weight a category/measurement parameter performance relative to at least one other category/measurement parameter performance in combining performances.

As discussed above, each category parameter may contain several measurement parameters. To produce a category performance or average of all measurement parameters in the category, a weighted average of all of the performance ratings for the measurement parameters is made by performance calculator 26.

Referring to FIG. 2, a category or reporter set that includes weighting may be signified in some manner such as with an asterisk, e.g., reporter set 52 includes an asterisk. Those without such an indication are weighted equally.

Weighter 34 may be implemented in any well known fashion. For instance, a separate graphical user interface (not shown) allowing weighting assignments to parameters may be utilized.

C. Indicator Icon Details

As best shown in FIGS. 3 and 5, each performance indicator icon 47, 147 includes at least two portions and preferably three portions 100, 102, 104. Each portion 100, 102, 104 indicates a performance status for a corresponding performance period. In one preferred embodiment, indicator icon 47, 147 is in the form of an arrow having three portions. A tail portion 104 of an arrow icon may represent, for example, a baseline performance status. This could be, for example, an average of all measurement periods prior to the previous measurement period or a sum of those, or simply the measurement for three periods ago. A middle portion 102 may represent, for example, the immediately previous performance status period. Since portions 102, 104 are historical in nature, they may be omitted or left with no indication, e.g., transparent where color is otherwise used to make an indication. An arrow head portion 100 represents the current performance status period.

With respect to the performance status indications made by the portions, color is one preferred mechanism for making the indications. In one embodiment, three colors are used: green, yellow and red. The colors used are derived from the parameter's performance for the particular performance period, which is defined by how far above or below target the corresponding value is. As discussed above, zero percent (0%) performance means the measurement's value is equal to its target; a positive value means the measurement's value was better than its target by some factor and a negative value means the measurement's value was worse than its target by some factor.

In one embodiment, a Green status is derived if the performance is greater than or equal to the maximum of zero or zero minus a tolerance cutoff percentage. The Yellow status is derived if the performance is greater than or equal to the minimum of zero or zero minus a tolerance cutoff percentage. The tolerance cutoff percentage is by default 10% for all measurements, but for any given measurement, the cutoff percentage can be overridden by the measurement owner, i.e., user that makes measurement available, to what is appropriate for that measurement. The Red status is derived for all other conditions not met by the Green or Yellow statuses. Uncolored or transparent status indicates no data was available for that period (only valid for last period and baseline period) or an indication was not requested.

With further regard to the tolerance cutoff percentage, in an alternative embodiment, reporter 28 may also accept a negative value. More specifically, the norm is to treat measurements that perform “equal to or better than their target” as a positive performance and a Green status. Yellow, therefore, means you missed the target by a little bit. Some users, however, wish to portray the Yellow status as “approaching the target.” That is, the measurement is nearing its target. Reporter 28 handles this by specifying a negative tolerance cutoff percentage. A value of −10%, for example, produces a status of Yellow if you are “making your target but are within 10% of missing it.” Then, Green status becomes “you made the target, and are >10% away from it.” Red becomes “you missed the target.”

Referring to FIG. 5, a position of indicator icon 47, 147 also provides an indication of the trend of the current performance. In one embodiment, five positions are provided as follows: Direction 1, indicator 47A: The current measurement has improved from the previous period by a factor of 2 (e.g., a jump from red to green). Direction 2, indicator 47B: The current measurement has improved from the previous period by a factor of 1 (e.g., a jump from yellow to green or red to yellow). This direction may also occur if the last two periods have the same status, and the current measurement's performance is better than the last period's performance. Direction 3, indicator 47C: The current measurement is the same as the previous period. Direction 4, indicator 47D: The measurement has degraded from the previous period by a factor of 1 (e.g., a jump from green to yellow or yellow to red). This direction may also occur if the last two periods have the same status, and the current period's performance is worse than the last period's performance. Direction 5, indicator 47E: The measurement has degraded from the previous period by a factor of 2 (e.g., a jump from green to red). If the last measurement period had no data, then it may be treated as a red to determine the direction of the indicator 46.

E. Data Retriever

Selecting any given parameter name or related performance indicator icon 47, 147, for instance, by clicking thereon in reporter GUI 44, instigates data retriever 36 to retrieve first level data 38 (FIG. 1) from a supporting measurement system. Reporter 28 then constructs a first level data drill down GUI for that parameter, which includes background or detail information about the parameter.

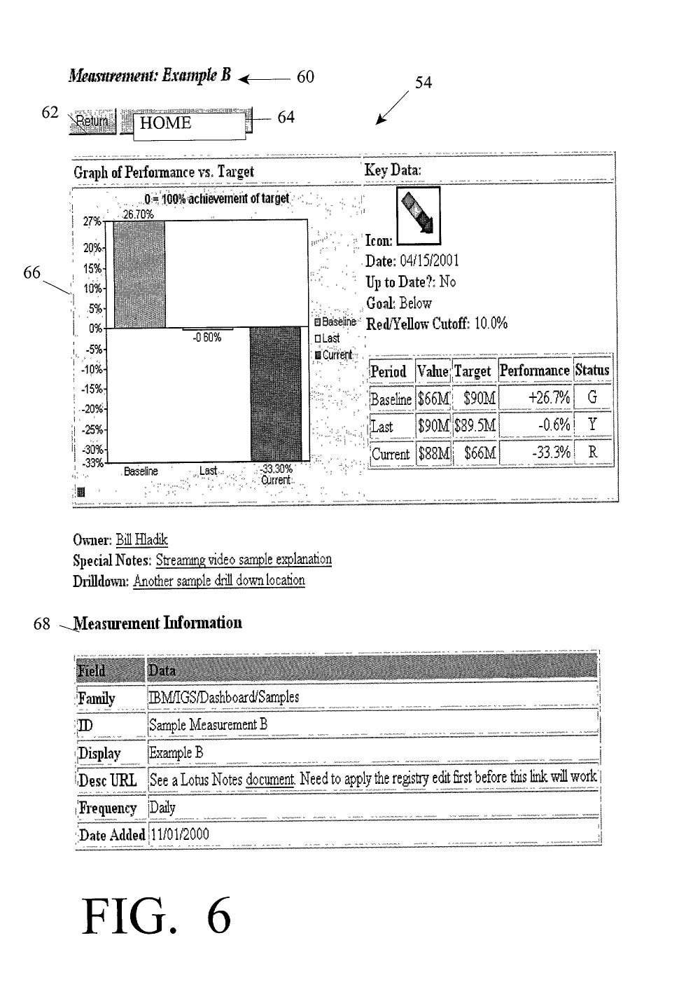

FIG. 6 illustrates an exemplary first level data drill down GUI 54 for a measurement parameter. This GUI may include, for example, the name of the parameter 60, e.g., Example B; navigation buttons including a “Return” button 62 to take the user back to the previous page from which they came; a “Home” button 64 to take the user to the page defined as the home page for the reporter set; a table 66 including measurement and performance data; and measurement information 68.

Table 66 may include a bar graph of the performance ratings for the measurement's baseline period, last measurement period and current measurement period. The line at 0% means 100% achievement of target. Anything above that line means it beat the target and below that line means it missed the target. Each bar is colored according to its status: Red, Yellow or Green. The height of the bars refers to the performance. The right hand side of the table may contain the measurement data including, for example: Indicator Icon Type (if this measurement has a second level of data, this indicator may be linked to that location, e.g., a uniform resource locator URL); Date: the last instance of this measurement in the system; Up to Date?: A yes or no indicating if the measurement is current or not (taking into account any grace period); Goal: showing whether the measurement is trying to be Above or Below target or in a Range; Threshold Cutoff Percentage (called Red/Yellow Cutoff % in FIG. 6); and a table showing the data for the three measurement periods of Baseline, Last/Previous, and Current. This latter table may contain, for example: Value: the measurement's value; Target: the corresponding target value; Performance: Performance rating; and Status: (G)reen, (Y)ellow, or (R)ed.

If a user (called an Owner in FIG. 6) is recorded for the measurement parameter, then the name may be displayed. Usually, the user name (or whatever text they chose to display) is linked to an e-mail address or a web site. If the user recorded any “Special Notes” for the measurement, they may be displayed.

Measurement information 68 may include a table of information about this measurement parameter. Some fields may be selectable because they were defined as URL's by the measurement owner, indicating there is another location to visit to see the information for that particular field. If this is the case, data retriever 36 accesses or retrieves second level data 40 (FIG. 1). The second level data may require construction of another GUI, or be presented as a Web site, etc.

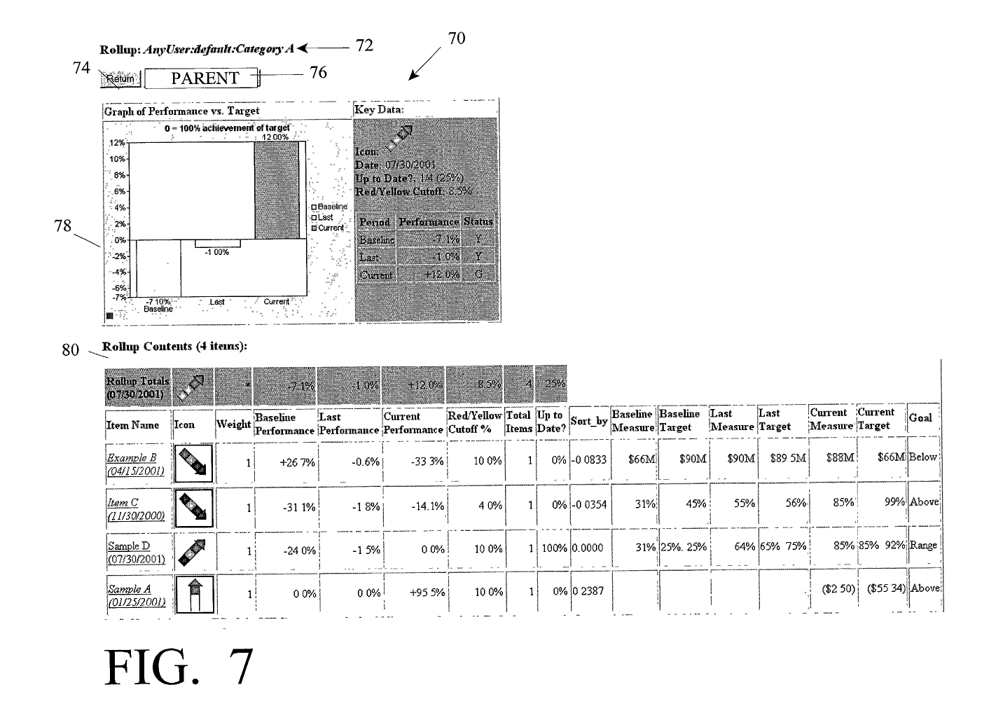

FIG. 7 illustrates an exemplary first level data drill down GUI 70 for a category parameter. This first level data drill down GUI is very similar to GUI 54. GUI 70, however, contains data related to the category, and not an individual measurement. This GUI may include, for example, the name of the category 72; navigation buttons including a “Return” button 74 to take the user back to the previous page from which they came; a “Parent” button 76 to take the user to the parent reporter page; a table 78 including category and performance data; and a category contents table 80.

Table 78 may include a bar graph, similar to the one discussed above, of the performance ratings for the category's baseline period, last measurement period and current measurement period. The right hand side of the table may contain the category data similar to the measurement data discussed above, i.e., Indicator Icon Type; Date; Up to Date?; Goal (not shown); and a table showing the data for the three measurement periods.

Category contents table 80 (called “Rollup Contents” in FIG. 7) may include a table of information about each measurement parameter in the category. This table may include, for example: A header/summary record (entitled “Rollup Totals”), which essentially repeats the data shown above, but aligned with a corresponding column for each measurement below; Item Name: the name of the measurement parameter, category parameter or reporter set parameter contained in this category (the date appears below the item name. Also, the background cell color is that corresponding to the type of item it is, e.g., category or reporter set. If it is an individual measurement, no cell color is applied); Performance indicator icon (if the item is a measurement with a first level drill down GUI or a category with all content pointing to the same first level drill down GUI, then this indicator is linked to that data); Weight: The weighting used in constructing the category; Baseline Performance: The performance for the category during the baseline measurement period; Last Performance: The performance for the category during the last measurement period; Current Performance: The performance for the category during the current measurement period; Threshold cutoff Percentage (Red/Yellow Cutoff %); and Total: The total number of measurements referenced in this category; Up to Date: What percentage of that total number of measurements are current or up to date?; Sort_By: A field generated for this item in the category to be used as a sorting field, e.g., Best or Worst type sorting, as discussed below. An exemplary sort_by formula is: current performance*(weight/sum_of₁₃ weights). The final six fields are only populated if the item is an individual measurement. They may include, for example: Baseline Measure: The value of the measurement during the baseline measurement period; Baseline Target: the corresponding target; Last Measure: The value of the measurement during the baseline measurement period; Last Target: the corresponding target; Current Measure: The value of the measurement during the baseline measurement period; Current Target: the corresponding target; Goal: The measurements goal—to be Above or Below target or in a Range.

Some fields may be selectable because they were defined as having second level data 40 (FIG. 1) available. If this is the case, data retriever 36 accesses or retrieves second level data 40. The second level data may require construction of another GUI, or be presented as a Web site, etc.

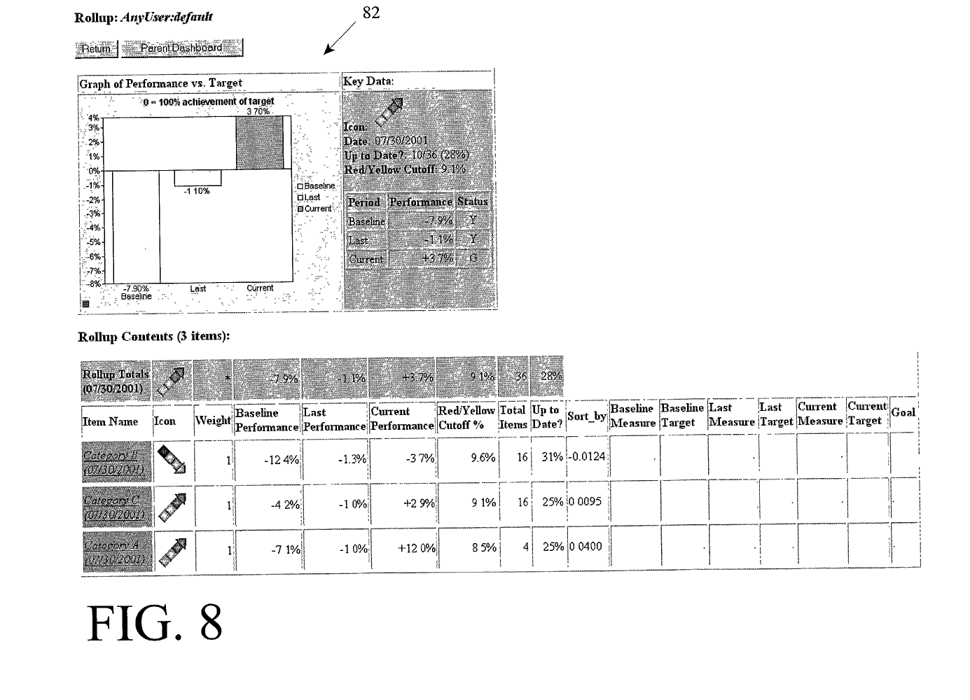

FIG. 8 is illustrates an exemplary first level data drill down GUI 82 for a reporter set parameter. This first level data drill down GUI is very similar to GUI 70. GUI 82, however, contains data related to the reporter set, and not an individual measurement or category. Access to second level data 40 for a reporter set may also be provided, as explained above.

F. Controller

Returning to FIG. 2, reporter GUI 44 includes a control section 90 that implements controller 32 (FIG. 1). The radio buttons of control section 90 are present on all GUIs associated with reporter 28 and allow the user to manipulate the reporter via controller 32 (FIG. 1).

Control section 90 may include, for instance, two pulldowns that allow the user to select a reporter user name and select a reporter set that the user has customized for reporter GUI 44 and related first level drill down GUIs. A special user name may exist called “Home.” Selecting this always takes the user back to the page defined by the system administrator as the home page for performance reporting system 10.

A filter can be implemented by reporter 28 by selecting viewing options. For instance, “All” shows all measurement parameters in the categories defined for this reporter set; and “Bad” shows only the “bad” or under performing measurement parameters—the ones whose current status is either yellow or red. In addition, a filter can be implemented by selecting ‘sort by’ options: “Alpha” sorts the measurement parameters alphabetically by name within the category; “Worst” sorts the icons from worst performing to best performing within each category based on current performance and assuming equal weighting; and “Best” sorts from best performing to worst performing base on current performance and assuming equal weighting. If different weighting is in effect for each item in the category, then that is taken into account for the sorting. A sort field is derived for each item in the category based on a formula such as: current performance*(weight/sum_of₁₃ weights). This allows for a more accurate sorting than simply using the current performance. For example, assume measurement parameters M1 and M2 are in the same category; M1 is weighted 100 and M2 is weighted −50; and M1 is performing at +2% and M2 at −11%. M1's status is therefore Green and M2 is Red. But, when sorted by a “Worst” criteria, M1 will appear before M2 despite their actual performance because, within the category, M1 carries such a high weighting. In other words, M1 is so much more important to the entity/business than M2, it should be performing well above its target.

It should be recognized that while the weighting example above discusses weighting in terms of measurement parameters, categories may also be weighted within a reporter set and sorted accordingly.

G. Alternatives

Performance reporting system 10 may be implemented on any variety of computer systems including pervasive devices such as a cell phone with web access or personal digital assistant like a Palm® Pilot. In this case, the GUIs discussed herein may be simplified to accommodate the smaller displays of these devices.

Data from performance reporting system 10 also include provisions for exporting data as known in the art.

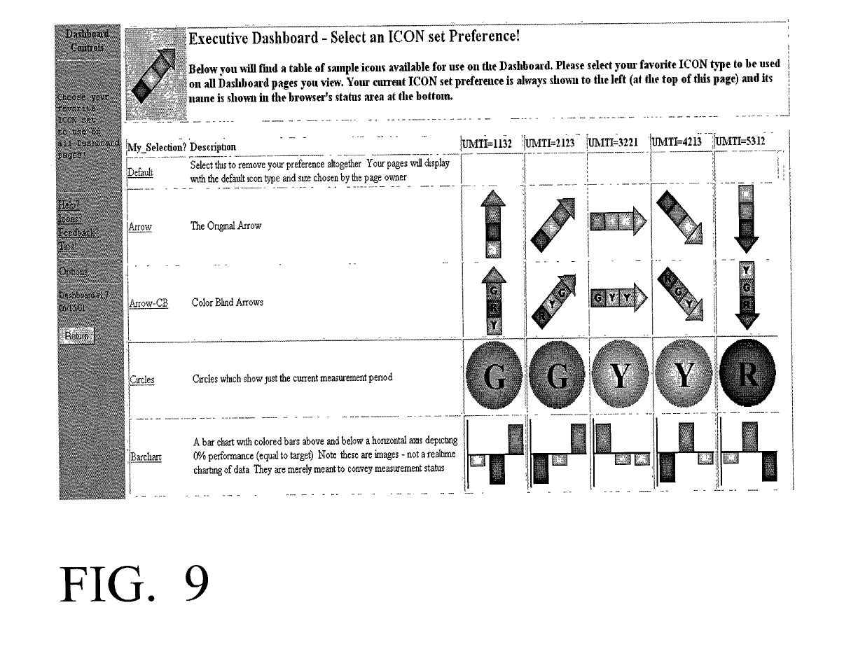

With reference to FIG. 9, system 10 may also include options for selecting different types of performance indicator icons. Other examples include a color blind arrow having letters signifying colors, circles to indicate only current performance, barcharts, targets, etc.

In the previous discussion, it will be understood that the method steps discussed preferably are performed by a processor, such as CPU 14 of system 10, executing instructions of program product 22 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A method for reporting performance of a plurality of parameters, the method comprising the steps of:
obtaining a measurement for each parameter, at least two parameters having different measurement dimensions;
calculating a performance for each parameter by comparing a respective measurement to a corresponding target; and
reporting performance of each parameter using an indicator icon that is independent of measurement dimension.

2. The method of claim 1, wherein the step of reporting further includes providing an indicator icon reporting on a combined performance of a category of parameters.

3. The method of claim 2, wherein the step of reporting further includes providing an indicator icon reporting on a combined performance of all of the plurality of parameters.

4. The method of claim 1, wherein the indicator icon includes:
a measurement baseline performance portion;
a previous period performance portion; and
a current period performance portion.

5. The method of claim 4, wherein the indicator icon further includes a trend indication.

6. The method of claim 1, further comprising the step of allowing a user to selectively conduct at least one of:
a) add or remove a parameter;
b) categorize at least two parameters;
c) combine at least two parameter performances into a category performance;
d) weight a parameter performance relative to at least one other parameter performance in combining performances into a category performance;
e) combine all parameter performances to attain an overall performance;
f) weight a category performance relative to at least one other category performance in combining all performances; and
g) customize the indicator icon.

7. A system for reporting performance, the system comprising:
a performance calculator to calculate a performance of a measurement parameter relative to a corresponding target; and
a reporter configured to create a graphical user interface that provides a performance indicator icon for a measurement parameter, wherein the indicator icon includes at least two portions, each portion indicating a different performance period.

8. The system of claim 7, wherein the performance indicator icon is independent of measurement dimension.

9. The system of claim 7, wherein a position of a performance indicator icon relative to the rest of the graphical user interface is representative of a performance trend.

10. The system of claim 7, wherein the graphical user interface provides a plurality of performance indicator icons for a plurality of measurement parameters.

11. The system of claim 10, wherein each measurement parameter has a corresponding measurement.

12. The system of claim 7, wherein the graphical user interface provides a performance indicator icon for a category that includes at least two measurement parameters, the category performance indicator icon indicating a combined performance of the at least two measurement parameters.

13. The system of claim 12, wherein the reporter includes a weighter for weighting a measurement parameter relative to at least one other measurement parameter in the same category in determining the combined performance.

14. The system of claim 12, wherein the graphical user interface includes an overall performance indicator icon indicating an overall combined performance of all categories.

15. The system of claim 14, wherein the reporter further comprises a weighter for weighting a category relative to at least one other category of performance in determining the overall combined performance.

16. The system of claim 10, wherein the reporter includes a categorizer that allows for the combination of at least two measurement parameters into a category.

17. The system of claim 10, wherein the graphical user interface includes an overall performance indicator icon indicating a combined performance of all the measurement parameters.

18. The system of claim 7, wherein the reporter further comprises a data retriever configured to retrieve data on a measurement parameter.

19. The system of claim 18, wherein the data includes at least a first level and a second level.

20. The system of claim 7, further comprising a measurer for accessing measurement data.

21. A computer program product comprising a computer useable medium having computer readable program code embodied therein for reporting on performance of a plurality of parameters, the program product comprising:
program code configured to obtain a measurement for each parameter, wherein at least two parameters have different measurement dimensions; and
program code configured to report performance of each parameter using an indicator icon that is independent of measurement dimension.

22. A system for reporting performance for a parameter, the system comprising:
means for calculating performance for a parameter; and
means for reporting performances of the parameter for at least three periods in a single indicator icon.
